(19) United States
(12) Patent Application Publication
(10) Pub. No.: US 2026/0303338 A1
(43) Pub. Date: Oct. 1, 2026

(54) DECENTRALIZED, SECURED DATA MANAGEMENT

(71) Applicant: Mysten Labs, Inc., Palo Alto, CA (US)

(72) Inventors: Konstantinos Chalkias, Dubai (AE); Joy Wang, New York, NY (US); Arnab Roy, Fremont, CA (US); Jonas Lindstrøm, Aarhus (DK); Adeniyi Abiodun, San Jose, CA (US); Abhinav Garg, Shrewsbury, MA (US); Janet Wu, San Mateo, CA (US); Ben Riva, Givatayim (IL)

(73) Assignee: Mysten Labs, Inc., Palo Alto, CA (US)

(21) Appl. No.: 19/421,687

(22) Filed: Dec. 16, 2025

Related U.S. Application Data
(60) Provisional application No. 63/777,071, filed on Mar. 25, 2025.

(51) Int. Cl. H04L 9/08; H04L 9/00

(52) U.S. Cl. CPC H04L 9/0866; H04L 9/085; H04L 9/50

(57) ABSTRACT

The present technology can provide decentralized security and data management using a decentralized system to generate a cryptography key for decrypting data and using a smart contract to determine access to the cryptography key. The system obtains a request associated with a cryptography key (e.g., a request to decrypt data), and the request indicates the user's identity, a smart contract, and the identity of the key. The system checks a smart contract on a blockchain to determine whether the access conditions are satisfied for the smart contract. When access is authorized, the system generates a derived, cryptography key using a threshold of independent parties (e.g., key servers and/or members of a multi-party computation (MPC) committee). Threshold cryptography can be used in which t-out-of-n independent parties are required to generate the derived key.

### CROSS-REFERENCE TO RELATED APPLICATIONS

This application claims the benefit of and priority to U.S. provisional application No. 63/777,071, filed on Mar. 25, 2025, which is expressly incorporated by reference herein in its entirety.

### BACKGROUND

While Web2 systems can securely store secrets using authentication mechanisms within Key Management Systems (KMS), blockchains lack standardized solutions for secret management, despite relying on similar authentication methods.

In Web2 systems, secrets are securely stored using Key Management Systems (KMS), such as AMAZON WEB SERVICES (AWS) KMS, GOOGLE CLOUD KMS, or HASHICORP VAULT. Web2 KMS solutions authenticate users via centralized mechanisms like passwords, multi-factor authentication (MFA), OAuth, or role-based access control (RBAC). These systems ensure that only authorized users or applications can access cryptographic keys and sensitive data, providing standardized encryption, rotation policies, and access logs. Web3, however, lacks standardized secret management solutions since blockchains are decentralized, permissionless, and immutable, making traditional KMS models incompatible.

### BRIEF DESCRIPTION OF THE SEVERAL VIEWS OF THE DRAWINGS

The present technology will be described with reference to the appended drawings. The drawings aid in the description of the present technology and are not to be considered to be limiting the scope of the appended claims. The accompanying drawings include:

FIGS. 1A-1F illustrate interactions between components of a block diagram for a decentralized key and data management system of the present technology in accordance with some embodiments.

FIG. 2 illustrates a sequence diagram of the present technology in accordance with some embodiments.

FIG. 3 illustrates a flow diagram for providing decentralized security and data management in accordance with some embodiments.

FIG. 4 shows a block diagram of a computing system for executing of the present technology in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Web3 lacks standardized secret management solutions since blockchains are decentralized, permissionless, and immutable, making traditional Key Management Service models incompatible. The absence of a unified key storage standard in Web3 increases the risk of private key loss, unauthorized access, and poor key security practices, making secret management a significant challenge in decentralized environments.

Solutions that require users to store secrets locally present challenges in many scenarios, such as when using hardware wallets, multisig wallets, passkey wallets, or zklogin wallets. Additionally, many use cases necessitate one-to-many sharing of secrets, such as selling access to encrypted content. In view of these and other challenges, the system and methods disclosed herein provide improvements for secret management for various blockchain use cases.

Challenges that are addressed by the system and methods disclosed herein include, but are not limited to, (1) applying the right cryptographic primitives, (2) providing an agile and generic system, providing a system that works seamlessly with blockchains, (3) providing a decentralized system, (4) providing a system that incentivizes honest participation; and (5) providing real world applications in various industries of such a system.

The system and methods disclosed herein can use identity based encryption (IBE), which includes operations of:
Setup: Generates a master secret key msk and a master public key mpk.
Derive(msk, id): Given a master secret key (msk) and an identity string (id), this operation generates a derived secret key (sk) for that identity.
Encrypt(mpk, id, m): Given a master public key (mpk), an identity (id), and a plaintext message (m), this operation returns the encrypted ciphertext (c).
Decrypt(sk, c): Given the derived secret key (sk) and the ciphertext (c) that was encrypted to the identity of sk, this operation computes the plaintext message (m).

IBE can be constructed, for example, from BLS signatures, or post-quantum cryptographic primitives.

The system and methods disclosed herein can use a combination of an access policy with decentralized, independent key servers to address the above-noted challenges. According to certain non-limiting examples, a smart contract that is “deployed at address P” can include an access policy that allows access to IBE derived keys for the identities that begin with the prefix P. Further, policies can be defined in the same programming language and modules as the smart contract, thereby enabling the sharing of types and functions and facilitating testing.

According to certain non-limiting examples, the key servers can be off-chain servers that hold IBE master keys and enforce access control using various application programming interfaces (APIs). These APIs can be existing APIs that are used on blockchain full nodes. These APIs can be used to evaluate that the smart contract's access policy functions (e.g., access conditions) are satisfied by the current state of the chain and the key request (without paying blockchain fees). User authentication can use the same mechanisms as exist on the blockchain to obtain user confirmation on retrieving the decryption keys on behalf of the user.

According to certain non-limiting examples, because the access policies are defined in a smart contract, the access policies can depend on any object available to smart contracts, including time, block height, etc.

According to certain non-limiting examples, security is enhanced by using a decentralized cryptography protocol. For example, threshold cryptography can be used. The cryptography protocol can use encryption to t-out-of-n IBE public master keys, which are held by independent servers. This cryptography protocol ensures that privacy is preserved unless t or more servers collude and that decryption is feasible as long as at least t servers are operational.

In another example, the cryptography protocol can use an implementation of a single IBE server using a multi-party computation (MPC) committee with t-out-of-n guarantees. This cryptography protocol uses cryptographic Distributed Key Generation (DKG) protocols for generating the master keys, and allows for changing committee members without impacting the master public key using cryptographic key rotation protocols.

Additionally, the derived keys can be encrypted under the user's ephemeral encryption key, thereby protecting against man-in-the-middle and replay attacks. Additionally or alternatively, the derived key can be verifiable.

According to certain non-limiting examples, a user can choose the set of servers being used for its encryption (e.g., the servers can be chosen from a possibly large set of servers) based on various criteria such as regulatory constraints. Different servers may have different deployments. For example, the servers could be deployed as cloud servers, or trusted execution environments (TEEs). Different servers may reside in different locations and jurisdictions, and/or have different costs and performance.

According to certain non-limiting examples, a single server can be implemented by a permissionless MPC committee of independent parties, utilizing protocols such as staking to incentivize honest participation, or by a permissioned committee of independent parties.

Users may even combine the above-discussed options. For instance, a user could use a 2-of-3 threshold scheme, distributing control across its wallet backend and two distinct MPC committees, each with its own unique configuration. This setup allows for enhanced security and flexibility, which can be used by users to adapt the scheme to their specific requirements.

According to certain non-limiting examples, once a user retrieves a threshold of the derived decryption keys from the servers, those canbe used to locally decrypt the ciphertext or be uploaded to the blockchain to trigger decryption on-chain.

For example, on-chain decryption can be used when implementing conditional encryption in which secret data is encrypted to a specific on-chain event, and, once that event occurs, anyone can retrieve the decryption keys and trigger on-chain decryptions.

Example use cases in which on-chain decryption can be useful can include: (i) time-lock encryption in which the decrypted data is to be made available/revealed to all from a given time forward; (ii) decentralized autonomous organization (DAO) in which votes are encrypted until all DAO members have posted their encrypted votes, triggering the votes to be decrypted and tallied; and (iii) frontrunning prevention in which trades are encrypted and committed by the blockchain after which anyone can decrypt and execute the trade; (iv) event-based encryption with dependency on on-chain events triggered by games like Bingo, etc.

Example use cases in which off-chain decryption can be useful can include: (i) private personal storage in which the the encrypted files are stored off-chain and only the owner is allowed access to the encrypted files; (ii) private file sharing in which the encrypted files are stored off-chain and access is allowed to only to the sender and receiver; and (iii) private content gating in which the encrypted files are stored off-chain and access is allowed to only paying subscribers.

The above is a description of some of the advantages of the present technology. Additional features and advantages will be addressed in more detail herein.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software. In some instances, a user can refer to a user account associated with a particular electronic device.

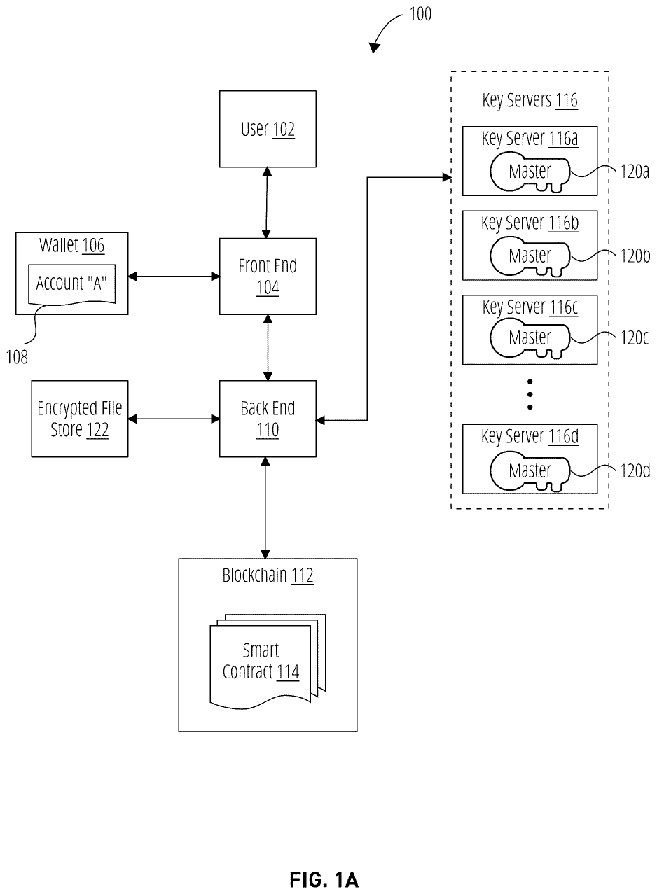

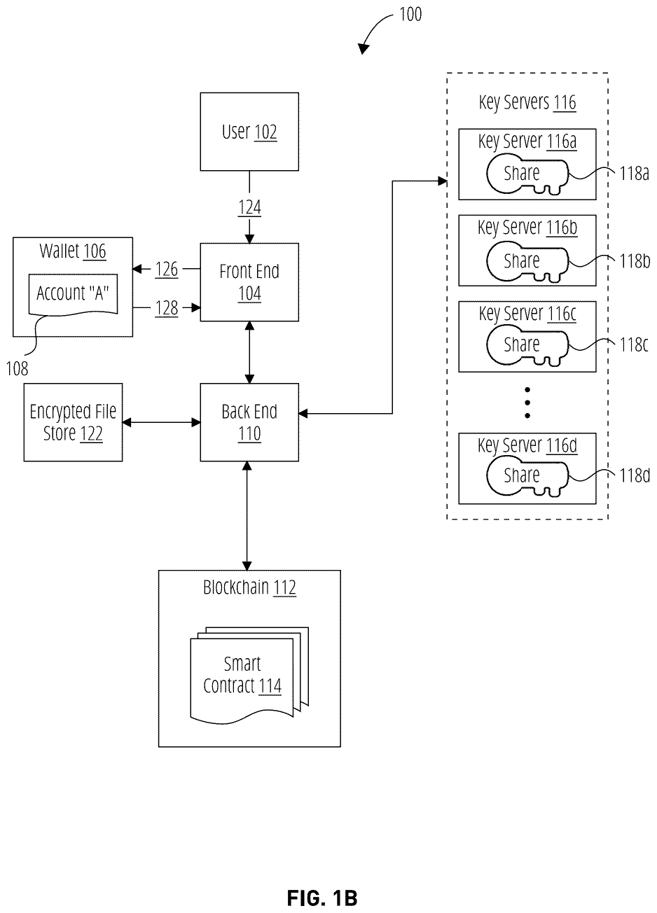

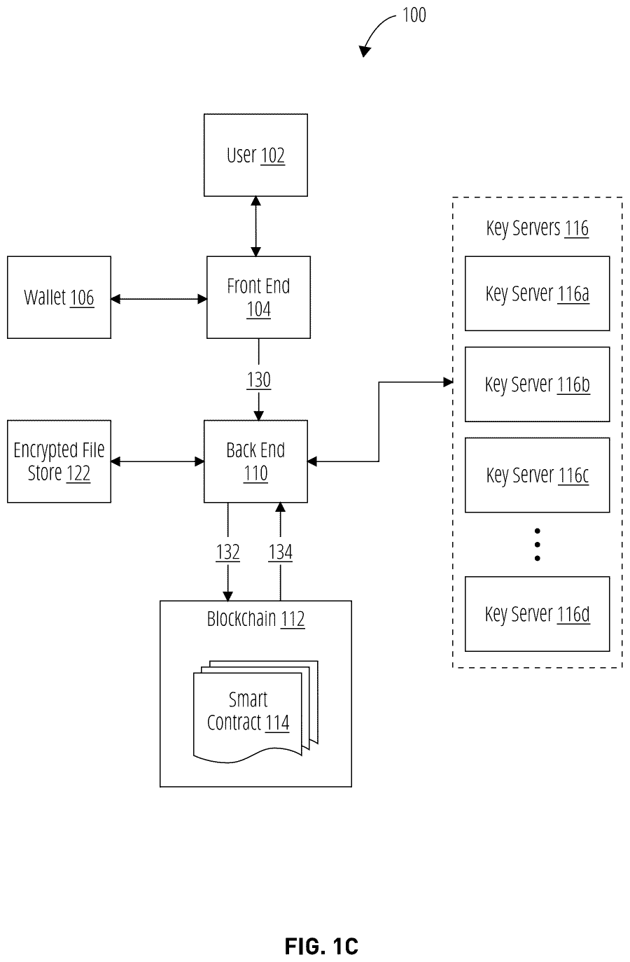

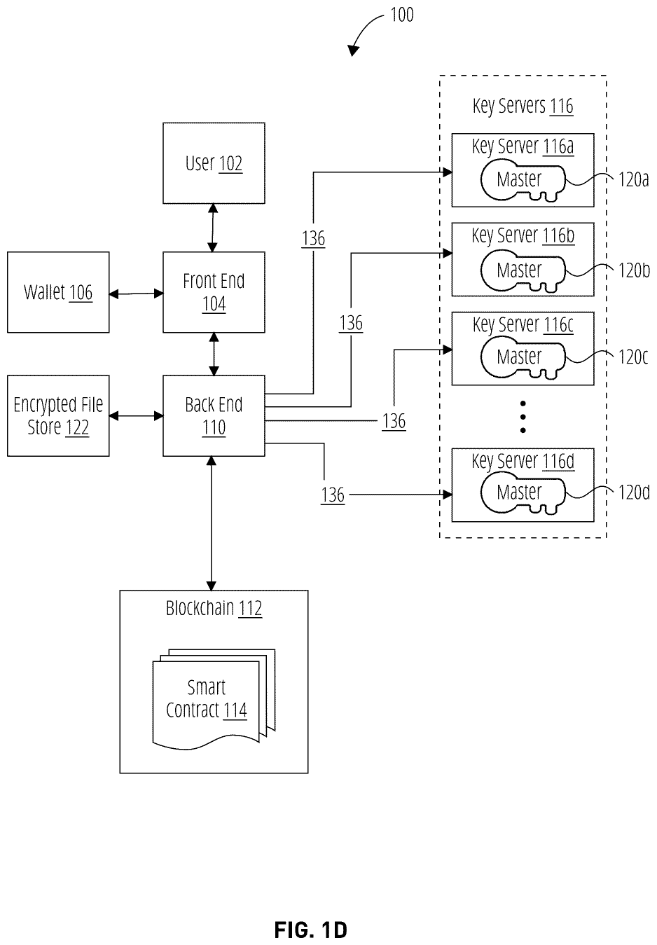

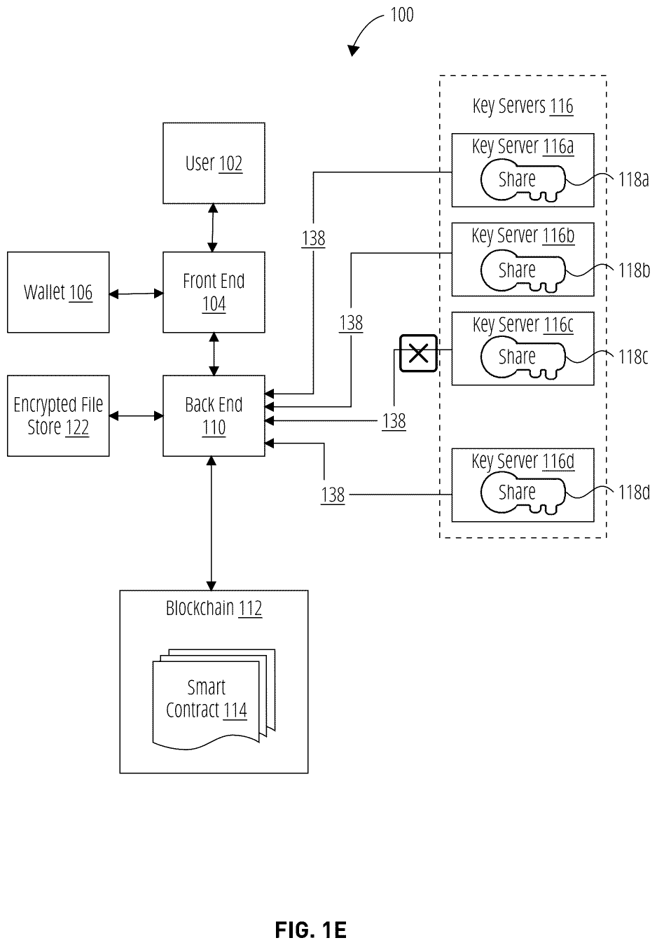

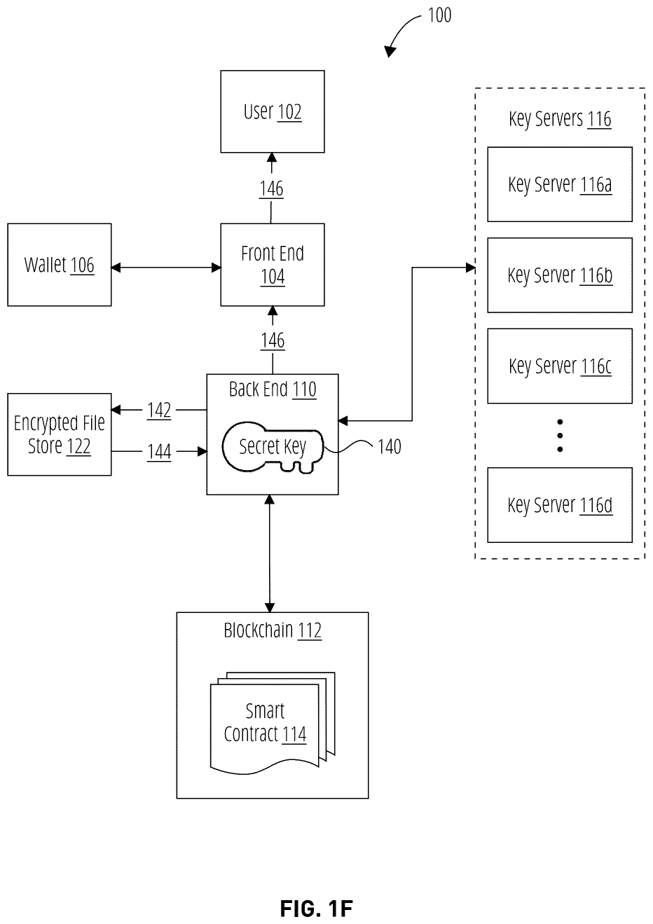

FIG. 1A illustrates system 100, which provides decentralized security and data management. According to certain non-limiting examples, system 100 includes user 102, front end 104, wallet 106, back end 110, blockchain 112, key servers 116, (e.g., key server 116a, key server 116b, key server 116c, and key server 116d), encrypted file store 122, and decentralized app 150.

User 102 can have an account (e.g., account A 108) on wallet 106 that allows user 102 to store information and data related to blockchain 112. User 102 can interact with a decentralized app 150 for functionalities for interacting with wallet 106. According to certain non-limiting examples, decentralized app 150 (Dapp) that provides a front end 104 (e.g., user interface such as website or application) through which user 102 provides inputs for interacting with blockchain 112, including, for example, creating, accessing, or interacting with smart contracts on blockchain 112 or performing transactions on blockchain 112. Decentralized app 150 can also include back end 110 for providing various application functions. In some embodiments, front end 104 or back end 110 can provide functionality for interacting with key servers 116 and encrypted file store 122.

According to certain non-limiting examples, blockchain 112 can be a decentralized/distributed ledger with growing lists of records (blocks) that are securely linked together via cryptographic hashes. Each block contains a cryptographic hash of the previous block, a timestamp, and transaction data.

Smart contracts 114 on blockchain 112 can be self-executing contracts with their terms directly written into lines of code. For example, a smart contract can be a type of automated program that is stored and executed on a blockchain network. The contract is automatically triggered and enforced when predefined conditions are met, without the need for intermediaries.

Key servers 116 directly and independently interact with blockchain 112 to evaluate access-control policies encoded in smart contracts 114. For a request, a key server 116 performs its own read-only policy check (e.g., a view/simulate call) against blockchain 112 and does not rely on front end 104 or back end 110 for authorization decisions. This removes the need to trust intermediate components for policy enforcement.

Two operational settings are supported. (i) Client-side decryption: front end 104 interacts directly with key servers 116, obtains decryption material, retrieves the encrypted file from encrypted file store 122, and decrypts locally for user 102. Back end 110 has no role in decryption in this setting. (ii) Server-side decryption: front end 104 or back end 110 interacts with key servers 116, which still independently check policy on blockchain 112, then key servers 116 obtain the encrypted file from encrypted file store 122, perform decryption, and return plaintext to front end 104 or back end 110 for delivery to user 102. In either setting, back end 110 (when present) may act as a gateway to implement rate limiting, usage quotas, logging, or additional application-layer access controls without substituting for the key servers'on-chain policy checks.

Key servers 116 support two distinct arrangements for deriving decryption material. (i) multi-party computation (MPC)-committee (single-server emulation): a committee of independent participants collectively holds shares of a single master secret key. Upon an authorized request, participants return a derived-key share computed from its private share; any t-out-of-n derived-key shares can be combined to reconstruct the full derived key. (ii) Independent key servers: key servers hold their own master secret key (e.g., master 120a, master 120b, master 120c, and master 120d). Upon an authorized request, servers return an independent derived key; possession of at least T out of N independent derived keys enables decryption.

In the MPC committee example, a secure multi-party computation (MPC) process can be used by a set of participants, called a committee, that collectively holds shares of a single master secret key. Each participant retains its private share. During authorized derivation participants compute derived-key shares without disclosing their private shares. Any t-out-of-n derived-key shares ofcan be combined to reconstruct the full derived key. The MPC protocol can ensure that no participant can control or generate the full key by itself, providing distributed trust.

In the independent key servers example, a threshold policy can be realized with independent key servers 116, each holding an independent master secret key. Upon authorization, each server returns an independent derived key to the requesting component (front end 104 in the client-side setting, or back end 110/key-server coordinator in the server-side setting). The ciphertext is protected such that possession of at least T out of N independent derived keys enables decryption; fewer than T keys yield no information. This approach enhances security by limiting the impact of compromise of any single server and provides robustness in decentralized systems.

According to certain non-limiting examples, the derived key material is used to decrypt the encrypted data (also referred to as ciphertext, whereas unencrypted data can be referred to as plaintext). In a first protocol independent key servers, each of N key servers returns an independent derived key and any t out of n derived keys suffice to decrypt the ciphertext under a threshold-protected encryption policy.

Additionally or alternatively, in a second protocol (MPC-committee emulating a single key server), a committee of n members holds shares of a single master secret key. Upon authorization, each member outputs a derived key share and any t out of n derived-key shares can be combined to reconstruct the derived key (client-side setting), or the committee executes an MPC procedure to compute the derived key and optionally decrypt the ciphertext without exposing the derived key. outside the committee (server-side setting).

According to a third protocol, a hybrid arrangement combines both models. For example, decryption may require (A) a derived key reconstructed from t out of n committee members (MPC arrangement) and (B) at least T out of N independent derived keys from distinct key servers. This composite threshold enforces separation of trust domains and supports heterogeneous provider mixes.

FIG. 1B illustrates the first set of steps (e.g., steps 124, 126, and 128) common to both operational settings. First, user request 124 is sent from user 102 to front end 104 of decentralized app 150. User request 124 can include an identifier of user 102, credentials of user 102, and an identifier of the data or file that is being requested. wallet request 126 is sent to wallet 106 including, for example, the user's credentials. For example, access to account A 108 of wallet 106 can be obtained when the user provides their credentials to log into their account. For example, the credentials can include a private key that is stored on the user's device and is protected against unauthorized access via a PIN, or password. The user may have previously logged into the account A 108 before sending user request 124. Signed approval 128 can indicate that the user is an authorized user associated with account A 108.

FIG. 1C illustrates a second phase in which a decryption request is formed. Decryption request 130 can include a message that identifies which key is requested (e.g., a key_id), the signed approval 128, and an identifier/address of the encrypted data (e.g., a blob_id for network/blob storage). In some embodiments, decryption request 130 further includes an ephemeral public key associated with front end 104 or back end 110 to enable secure delivery (e.g., key wrapping) of any derived key material.

Policy verification is performed directly by key servers 116. Upon receiving decryption request 130 (or a subset thereof sufficient to identify the request), each key server 116 issues a read-only policy check 132 to blockchain 112 against the relevant smart contract 114 to determine whether the on-chain conditions are satisfied. When the conditions of smart contract 114 are not satisfied, the key server returns a denial. When the conditions are satisfied, policy response 134 authorizes proceeding to decentralized key derivation and/or decryption. This independent on-chain verification by each key server 116 occurs in both operational settings.

FIG. 1D, FIG. 1E, and FIG. 1F illustrate a flow in which front end 104 or back end 110 interacts with key servers 116, which independently verify policy on blockchain 112. After authorization, key servers 116 obtain the encrypted data from encrypted file store 122 using the provided blob_id and perform decryption.

In the independent key servers example, a coordinator obtains at least T out of N independent derived keys and uses them to decrypt the ciphertext. In the MPC-committee example, the committee jointly computes the derived key (or directly decrypts via MPC) without revealing private shares. The resulting plaintext is returned to front end 104 or back end 110, which then returns the plaintext to user 102. Back end 110, when used, can additionally provide rate limiting, request aggregation, logging, and application-specific access controls; however, key servers 116 do not rely on back end 110 for policy enforcement.

FIG. 1D illustrates step 136 for providing decentralized security and data management. Generate-key request 136 can be a message requesting key shares from key servers 116 (e.g., key server 116a, key server 116b, key server 116c, and key server 116d).

Identity-based encryption (IBE) primitives can be used for encryption and decryption. A key server (or a committee thereof) holds a master secret key (msk) corresponding to a master public key (mpk). The data can be encrypted using an “Encrypt” function, which takes a user identity (user_id) and the master public key (mpk):
c=Encrypt(mpk, user_id, m),

wherein “m” is the plaintext for the data (i.e., the unencrypted data) and “c” is the ciphertext for the data (i.e., the encrypted data). To generate a user-specific secret key (sk) for decrypting data, a “Derive” function is used with the user identity (user_id) and a master secret key (msk):
sk=Derive(msk, user_id).

Decrypting the ciphertext “c” can be performed using a “Decrypt” function which receives as arguments the ciphertext (c) and the derived secret key (sk):
m=Decrypt(sk, c).

In the independent key-server example, the encryption policy can protect content under a set of master public keys {mpk₁, . . . , mpk_N} with a threshold T-of-N recovery using the corresponding derived keys from the respective servers.

In MPC-committee example, the master secret key is shared among committee members; members output derived-key shares that combine (t-out-of-n) to reconstruct the derived key, or jointly decrypt via MPC.

FIG. 1E illustrates step 138 for providing decentralized security and data management. Return key shares 138 sends the shares for the derived key (e.g., share 118a, a share 118b, a share 118c, a share 118d) from key servers 116 to back end 110. Upon receiving shares 118, back end 110 generates the derived key from shares 118. As discussed above, the derived key (e.g., derived secret key 140) can be generated using the first protocol (i.e., generating the derived key using respective key shares from independent key servers), the second protocol (i.e., generating the derived key using multi-party computation among independent committee members), or combination of the first and second protocols.

FIG. 1F illustrates the remaining set of steps (e.g., steps 142, 144, and 146) for providing decentralized security and data management. Fetch encrypted file 142 sends a decentralized app 150 to encrypted file store 122, requesting the encrypted data stored at the address (e.g., blob_id) previously provided in decryption request 130. Return encrypted file 144 sends the encrypted data from encrypted file store 122 to back end 110. Back end 110 then uses derived secret key 140 to decrypt the encrypted data to provide decrypted data (i.e., plaintext). According to certain non-limiting examples, return decrypted file 146 returns the encrypted data to user 102. Additionally or alternatively, return decrypted file 146 can include processing the decrypted data to generate a result based on the decrypted data, and return decrypted file 146 returns the encrypted data.

Decentralized app 150 can operate in a client-side embodiment or a server-side embodiment, depending on the configuration of decentralized app 150. In the client-side embodiment, front end 104 retrieves the encrypted data (142), receives it (144), and performs local decryption before returning plaintext to user 102. In the server-side embodiment, key servers 116 retrieve the encrypted data from encrypted file store 122, decrypt it, and return the plaintext to front end 104 or back end 110. The receiving component then forwards the plaintext to user 102. In both embodiments, optional gateway logic in back end 110 may implement rate limiting or similar general access controls while preserving the key servers'independent policy verification on blockchain 112.

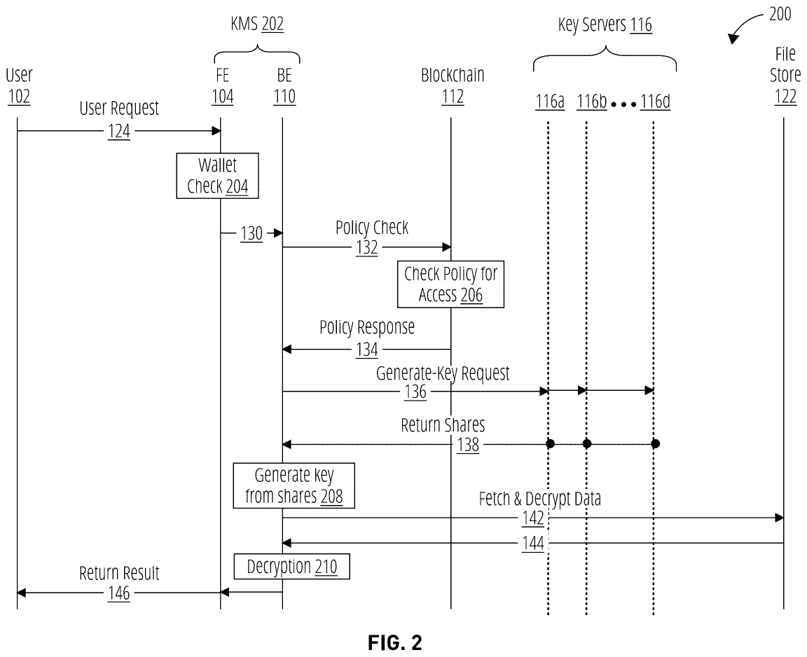

FIG. 2 illustrates a sequence diagram 200 for providing decentralized security and data management. Sequence diagram 200 outlines a secure, blockchain-integrated process for accessing encrypted files in two operational settings: (i) client-side decryption and (ii) server-side decryption. In both settings, each key server 116 independently verifies authorization by interacting directly with blockchain 112 (e.g., read-only/view calls to smart contract 114), and decryption proceeds only if the on-chain policy is satisfied.

After wallet check 204, the requester forms a decryption request 130 and transmits it to key servers 116. In the client-side setting this message originates from front end 104; in the server-side setting it originates from back end 110 (or is proxied by back end 110). Upon receipt, each key server 116 performs its own policy check 132 against smart contract 114 on blockchain 112 to determine whether access conditions are satisfied. When conditions are not satisfied, the key server returns a denial. When conditions are satisfied, policy response 134 authorizes proceeding to key derivation and subsequent decryption.

In some embodiments, the policy check can be a dry-run policy check 132 or a real-run policy check 132. A Dry-Run Policy Check is a read-only/view simulation (no state change) that evaluates predicates in smart contract 114 and returns authorize/deny. This is suitable when an on-chain authorization receipt is unnecessary. A Real-Run Authorization is a state-changing transaction that records authorization on-chain (e.g., issuance of an AccessVoucher including {key_id, user_id, requester_ephemeral_pk, expiry, nonce, usage limit}), emits an event, and may update counters/usage state. Key servers 116 verify either the dry-run result or the on-chain authorization record before releasing or using decryption material.

When access is granted, generate-key request 136 is sent to the key infrastructure. Two arrangements are supported: (a) Independent key servers—multiple key servers (e.g., 116a, 116b, 116c, 116d) each hold an independent master secret key and, upon authorization, return independent derived keys. Any T out of N independent derived keys enable decryption. (b) MPC-committee—committee members collectively hold shares of a single master secret key and, upon authorization, return derived-key shares (or jointly compute the derived key via MPC); any t out of n shares reconstruct the derived key. Optional gateway logic in back end 110 may rate-limit or log requests but does not substitute for the key servers'on-chain policy checks.

Decentralized app 150 can be configured for client-side decryption or server-side decryption. In client-side decryption the front end 104 collects key material—either (i) at least T out of N independent derived keys from independent key servers or (ii) at least t out of n derived-key shares from an MPC committee—and combines them (or receives an MPC-produced derived key wrapped to an ephemeral public key). Front end 104 then issues fetch encrypted file 142 to encrypted file store 122, receives return encrypted file 144, locally decrypts the ciphertext with the reconstructed derived key, and returns plaintext to user 102 (return decrypted file 146).

In server-side decryption, key servers 116 obtain the encrypted data from encrypted file store 122 using the provided blob_id, derive/compute decryption material as above (independent derived keys or MPC-produced derived key), perform decryption within the key-server infrastructure, and return plaintext to front end 104 or back end 110 for delivery to user 102.

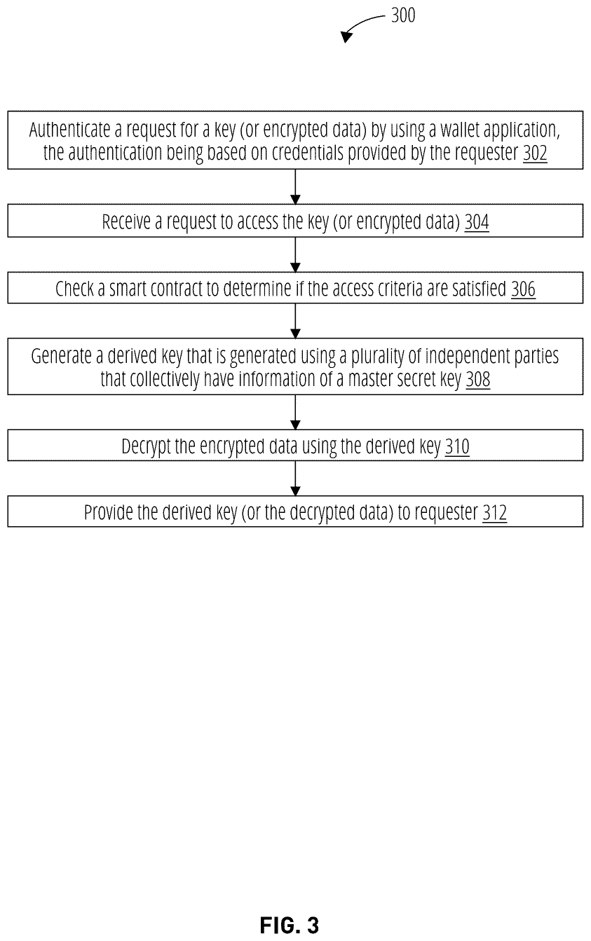

FIG. 3 illustrates an example of method 300 for providing decentralized security and data management. Although the example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

According to some examples, block 302 of the method includes authenticating a request for a key (or a request for encrypted data) using a wallet application, the authentication being based on credentials provided by the requester.

According to some examples, block 304 of the method includes receiving a request to access the key (or encrypted data). For example, back end 110 illustrated in FIG. 1A may receive a request to access the key (or encrypted data). For example, the request for the encrypted data can refer to a smart contract, which provides conditions (also referred to as access criteria) that must be satisfied to obtain derived secret key 140.

According to certain non-limiting examples, the request for the encrypted data can include a signature, indicating that the user has been authenticated by a wallet application. Additionally or alternatively, the requester can request the derived key, and the requester can separately access the encrypted data and perform the decryption.

According to some examples, block 306 of the method includes checking a smart contract to determine if the access criteria are satisfied. For example, blockchain 112 illustrated in FIG. 1A may check smart contract 114 to determine if the access criteria (e.g., conditions of the smart contract) are satisfied.

According to certain non-limiting examples, the smart contract is on a blockchain, which provides various security guarantees. The smart contract is checked to determine. whether the request satisfies access conditions in the smart contract. The smart contract can provide access authorization to the decryption key of the smart contract.

According to certain non-limiting examples, checking the smart contract can include providing a first identifier associated with the requester (e.g., user_id) and a second identifier associated with the requested key (e.g. key_id). These identifiers are used to check whether the conditions of the smart contract are satisfied.

According to certain non-limiting examples, the conditions of the smart contract can include a time-based condition, an event-based condition, an identity-based condition, or a financial condition.

According to certain non-limiting examples, the smart contract can be used for a voting use case in which the encrypted data includes votes, and a time-based condition prevents the votes from being decrypted before a predefined voting deadline. For the voting use case, the votes can be anonymized by tallying the votes and only presenting the results of the voting (e.g., the winner of the vote) to the requester. For example, the results can be sent to user 102 or can be posted in unencrypted form on blockchain 112.

According to some examples, block 308 of the method includes generating decryption material using one of two arrangements. (i) Independent key servers: each server holds its own master secret key and, upon authorization, returns an independent derived key; any T-out-of-N derived keys suffice to decrypt. (ii) MPC-committee: committee members hold shares of a single master secret key and, upon authorization, output derived-key shares (or jointly compute the derived key via MPC); any t-out-of-n shares reconstruct the derived key.

Threshold cryptography details. For the independent key-server arrangement, the encryption policy is configured so that decryption succeeds when at least T out of N independent derived keys are presented; fewer than T keys yield no information. For the MPC-committee arrangement, any t out of n derived-key shares suffice to reconstruct the derived key (or to complete an MPC decryption), with no single member able to recover the master secret key.

According to certain non-limiting examples, the derived key can be based, at least in part, on an identity associated with the requester, which is used for identity-based encryption (IBE).

In the independent key-server arrangement, the independent parties are key servers that each hold an independent master secret key and produce independent derived keys upon authorization; combination of at least T out of N derived keys enables decryption.

In the MPC-committee arrangement, the independent parties are committee members that each hold a private share of a single master secret key. Upon authorization, members contribute derived-key shares that are combined (t-out-of-n) to reconstruct the derived key, or the members jointly compute decryption via MPC without exposing private shares.

Hybrid compositions are also supported. For example, a policy may require both (A) a derived key reconstructed from t out of n committee members and (B) at least T out of N independent derived keys from distinct key servers. This mixes trust domains and enforces composite thresholds.

Threshold cryptography can be enabled by redundancy such that decryption succeeds even when fewer than all independent parties participate. Parameters (T, N) and (t, n) are selectable to meet availability and security goals. These mechanisms limit the impact of compromise of individual parties and improve fault tolerance.

According to certain non-limiting examples, the derived key is an ephemeral encryption key that protects against replay attacks.

According to certain non-limiting examples, correctness of the derived key (or decryption) can be accompanied by a proof that is verifiable under the corresponding master public key (mpk), enabling public verification without exposing the master secret key (msk).

According to certain non-limiting examples, the system can employ identity-based encryption (IBE) in which data is encrypted to an identity (user_id) under a master public key (mpk), and decryption uses a derived key produced from the corresponding master secret key (msk). Formally:
c=Encrypt(mpk, user_id, m)
m=Decrypt(Derive(msk, user_id), c)

The master public key (mpk) corresponds to the master secret key (msk). In the independent key-server arrangement, a set of master public keys {mpk₁, . . . , mpk_N} may be used with a T-of-N decryption policy over the corresponding derived keys.

According to some examples, block 310 of the method includes decrypting the encrypted data using the derived key. In the client-side setting, front end 104 performs the decryption locally. In the server-side setting, key servers 116 perform decryption and return plaintext to front end 104 or back end 110 for delivery to user 102.

According to certain non-limiting examples, the request can be for the derived key, rather than decrypted data obtained using the derived key. In this case, the decryption of the encrypted data can be omitted.

According to certain non-limiting examples, decryption can be performed on-chain (e.g., using the blockchain) or off-chain (e.g., without using the blockchain). For example, the decryption can be performed off-chain by fetching the encrypted data from a computer-readable storage medium, which can be separate from the blockchain and using the derived key to decrypt the fetched encrypted data. Off-chain decryption can include retrieving the decrypted file from where it has been stored (e.g., encrypted file store 122), and the retrieved data can be decrypted using the derived key. For example, the encrypted data can be stored using decentralized storage such as WALRUS by MYSTENLABS. Erasure coding or another form of redundancy/error correction coding can be used to encode shards of the data at different locations. For example, decentralized storage can be used to store and retrieve binary large objects (blobs). Decrypting the encrypted data can include, assembling the encrypted data from the shards to provide assembled encrypted data and using the derived key to decrypt the assembled encrypted data.

For on-chain decryption, the encrypted data can be stored on the blockchain. On-chain decryption can include storing the encrypted data on the blockchain and retrieving the encrypted data from the blockchain to decrypt it. For on-chain storage of the encrypted data, zero-knowledge proofs or multi-party computation methods can be used to verify encrypted data without exposing plaintext information.

According to certain non-limiting examples, the derived key is generated using identity-based encryption (IBE) in which the data is encrypted using an identity associated with the user (user_id) and a master public key (mpk) and decryption is performed using the user_id and the derived key, which is derived from key shares based on shares of the master secret key (msk). The system uses IBE in which data is encrypted to an identity (user_id) under a master public key (mpk), and decryption uses a derived key tied to that identity. The derived key is obtained either (A) from an independent key server's master secret key (msk) (independent key-server arrangement), or (B) via MPC over shares of a single msk held by committee members (MPC-committee arrangement).
c=Encrypt(user_id, mpk, m), and the plaintext (m) is generated from the ciphertext (c) by the decryption operation
m=Decrypt(Derive(msk, user_id)), c).

In the independent key-server arrangement, a set of master public keys {mpk₁, . . . , mpk_N} may be used with a T-of-N policy over the corresponding derived keys; in the MPC-committee arrangement, Derive(msk, user_id) is computed via MPC without exposing private shares.

According to some examples, block 312 of the method includes providing the derived key (or the decrypted data) to the requester. For example, front end 104 illustrated in FIG. 1A may provide the derived key (or the decrypted data) to user 102. According to certain non-limiting examples, rather than providing the decrypted data, a result generated based on the decrypted data can be provided to the requester. Additionally or Alternatively, the decrypted data, a result generated using the decrypted data can be provided to the ledger of the blockchain (e.g., a result of tallied votes).

According to certain non-limiting examples, decryption off a blockchain can occur in a local or external environment, such as a user's device, a cloud server, or a secure enclave, where the encrypted data is retrieved and decrypted using a private key. The decrypted data remains private and does not interact directly with the blockchain, ensuring sensitive information is not exposed on the ledger. This method can be used to provide data privacy because it ensures that only encrypted data or references to it are stored on-chain.

Decryption on a blockchain can include executing cryptographic operations within a smart contract or using decentralized key management services to reconstruct decryption keys. Since blockchains are public and immutable, direct decryption can be infrequent, but zero-knowledge proofs or multi-party computation methods can be used to verify encrypted data without exposing plaintext information. This approach enhances transparency and security by ensuring access control and key management are governed by decentralized protocols rather than a single entity.

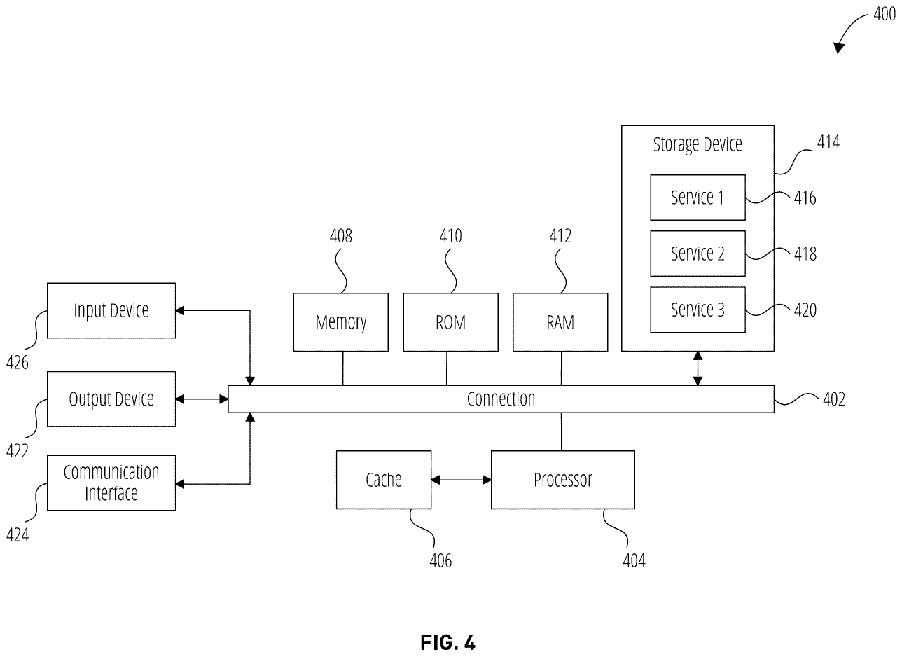

FIG. 4 shows an example of computing system 400, which can be for example any computing device making up system 100, or any component thereof in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit (CPU or processor) 404 and connection 402 that couples various system components including system memory 408, such as read-only memory (ROM) 410 and random access memory (RAM) 412 to processor 404. Computing system 400 can include a cache of high-speed memory 406 connected directly with, in close proximity to, or integrated as part of processor 404.

Processor 404 can include any general purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:

Aspect 1. A method for providing decentralized data security, the method comprising: obtaining a request to access encrypted data, the request referring to node API calls that simulate execution of a smart contract and providing authentication of a requester; check without submitting a transaction and without paying blockchain transaction fees.king a 22. The method of claim 1, wherein checking the smart contract comprises issuing one or more read-only blockchain the smart contract authorization when the request satisfies the conditions of the smart contract; obtaining, in response to the access authorization, a derived key from a plurality of independent parties, the plurality of independent parties collectively having information of a master secret key, the derived key being based, at least in part, on an identity associated with the requester and the information of the master secret key; and decrypting the encrypted data using the derived key to provide decrypted data.

Aspect 2. The method of aspect 1, wherein obtaining the derived key uses a decentralized key method in which the plurality of independent parties includes at least three key servers and obtaining the derived key includes: sending key requests to the least three key servers, a quantity of the least three key servers being an integer N, and a key server of the least three key servers using a master key share that is a share of a master secret key; receiving key shares from R key servers of the least two key servers, wherein R is less than or equal to N; and when R is greater than T, which is a minimum threshold for generating the derived key, combining at least T of the key shares to generate the derived key.

Aspect 3. The method of any of aspects 1-2, wherein obtaining the derived key uses a decentralized key method in which a set of the plurality of independent parties comprises a committee that uses multi-party computation (MPC) to generate a master key and obtaining the derived key includes: sending a key request to the committee; performing, by the committee, MPC to generate the master key; and generating the derived key using the master key.

Aspect 4. The method of aspect 3, wherein: the committee comprises N independent entities, N being an integer, and the master key depends on at least T independent entities of the N independent entities contributing to the performing of the MPC to generate the master key, wherein T is a minimum threshold for generating the derived key.

Aspect 5. The method of any of aspects 1-4, wherein: the threshold of independent parties each include information of a share of a master secret key that corresponds to a master public key, and ciphertext is generated using a master public key and an identity associated with the requester.

Aspect 6. The method of any of aspects 1-5, wherein checking the smart contract on the blockchain further includes: providing a first identifier associated with the requester and a second identifier of the conditions of the smart contract at least one of a time-based condition, an event-based condition, an identity-based condition, or a financial condition.

Aspect 7. The method of any of aspects 1-6, wherein the decrypting of the encrypted data using the derived key further includes decrypting of the encrypted data off of the blockchain by: fetching the encrypted data from a computer-readable storage medium that is separate from the blockchain to provide fetched encrypted data; and using the derived key to decrypt the fetched encrypted data.

Aspect 8. The method of any of aspects 1-7, wherein the encrypted data is stored on the blockchain using decentralized storage in which shards of the encrypted data are stored at respective independent locations, and decrypting the encrypted data using the derived key further includes: assembling the encrypted data from the shards to provide assembled encrypted data; and using the derived key to decrypt the assembled encrypted data.

Aspect 9. The method of any of aspects 1-8, wherein: the encrypted data are votes, the smart contract includes a time-based condition preventing the votes from being decrypted before a predefined voting deadline, and the method further comprises counting the votes of the decrypted data.

Aspect 10. The method of any of aspects 1-9, wherein the derived key is an ephemeral encryption key that protects against replay attacks.

Aspect 11. The method of any of aspects 1-10, wherein the derived key is verifiable using the master secret key.

Aspect 12. The method of any of aspects 1-11, wherein redundancy among shares of the master secret key stored at respective independent parties of the plurality of independent parties allows the derived key to be derived when fewer than all of the plurality of independent parties contribute to generating the derived key.

Aspect 13. The method of any of aspects 1-12, the method further comprising: authenticating the request by processing requester credentials by a wallet application to provide the authentication of the requester.

Aspect 14. The method of any of aspects 1-13, wherein the request includes a first identifier associated with the derived key and a second identifier associated with a storage location of the encrypted data.

Aspect 15. A computing apparatus configured to perform the method of any of aspects 1 to 14.

Aspect 16. A non-transitory computer-readable storage medium, the computer-readable storage medium including instructions that when executed by a computer, cause the computer to perform the method of any of aspects 1 to 14.

What is claimed is:

1. A method for providing decentralized data security, the method comprising:
obtaining a request associated with a cryptography key, the request referring to a smart contract and providing authentication of a requester;
checking a smart contract on a blockchain to determine whether the request satisfies access conditions in the smart contract,
obtaining, in response to the access authorization, a derived key as the cryptography key, the derived key being produced from decryption material contributed by a threshold of independent parties, the threshold of independent parties collectively having information of a master secret key, the derived key being based, at least in part, on an identity associated with the authorized access and the information of the master secret key.

2. The method of claim 1, wherein the request associated with the cryptography key is a request that depends on decrypting encrypted data using the derived key, and the method further comprises:
decrypting the encrypted data using the derived key to provide decrypted data.

3. The method of claim 2, wherein the decrypting of the encrypted data using the derived key further includes decrypting of the encrypted data off the blockchain by:
fetching the encrypted data from a computer-readable storage medium that is separate from the blockchain to provide fetched encrypted data; and
using the derived key to decrypt the fetched encrypted data.

4. The method of claim 2, wherein the encrypted data is stored using decentralized storage in which shards of the encrypted data are stored at respective independent locations, and decrypting the encrypted data using the derived key further comprises:
assembling the encrypted data from the shards to provide assembled encrypted data; and
using the derived key to decrypt the assembled encrypted data.

5. The method of claim 2, wherein decrypting the encrypted data is performed at least in part on-chain by program code executing on the blockchain, the program code using the derived key to compute plaintext or a deterministic result thereof, optionally employing zero-knowledge proofs and/or multi-party computation to avoid public exposure of the plaintext on the blockchain.

6. The method of claim 1, wherein the threshold of independent parties comprises independent key servers that hold an independent master secret key, and obtaining the derived key includes:
sending key requests to N key servers;
receiving independent derived keys from R of the N key servers, where R≤N; and
when R≥T, combining at least T of the independent derived keys to reconstruct the derived key.

7. The method of claim 6, wherein N=T=1 such that the derived key is obtained from a single key server after authorization.

8. The method of claim 1, wherein the threshold of independent parties of the plurality of independent parties comprises a multi-party computation (MPC) committee and obtaining the derived key includes:
sending a key request to the committee;
performing, by the committee, an MPC
protocol in which each member computes a derived-key share from its private share of a master secret key; and
combining at least t out of n derived -key shares to reconstruct the derived key.

9. The method of claim 8, wherein:
the committee comprises N independent entities, N being an integer, and
the master key depends on at least T independent entities of the N independent entities contributing to the performing of the MPC to generate the master key, wherein T is a minimum threshold for generating the derived key.

10. The method of claim 1, wherein the checking comprising at least one of: (i) a Dry-Run Policy Check that is read-only and does not change on-chain state, or (ii) verifying a Real-Run Authorization recorded on-chain.

11. The method of claim 1, wherein:
encryption is identity-based such that the encrypted data is generated using at least one master public key and an identity associated with the requester, and the derived key corresponds to a secret key derived for that identity from corresponding master secret keys.

12. The method of claim 1, further comprising:
selecting, by the requester and from a set of available independent parties, n independent parties as the plurality of independent parties, wherein the n independent parties are selected based on at least one of a deployment type, a location, or a jurisdiction of a selected independent party.

13. The method of claim 1, wherein checking the smart contract on the blockchain further includes:
providing a first identifier associated with the requester and a second identifier associated with the requested key, wherein the conditions of the smart contract comprise at least one of a time-based condition, an event-based condition, an identity-based condition, or a financial condition.

14. The method of claim 1, wherein the derived key is at least one of an ephemeral encryption key that protects against replay attacks or a verifiable key that is verifiable using the master public key.

15. The method of claim 1, wherein checking the smart contract comprises issuing one or more read-only blockchain node API calls that simulate execution of the smart contract without submitting a transaction and without paying blockchain transaction fees.

16. A computing system comprising:
at least one processor; and
a memory storing instructions that, when executed by the at least one processor, configure the computing system to:
obtain a request associated with a cryptography key, the request referring to a smart contract and providing authentication of a requester;
check a smart contract on a blockchain to determine whether the request satisfies access conditions in the smart contract,
obtain, in response to the access authorization, a derived key as the cryptography key, the derived key being produced from decryption material contributed by a threshold of independent parties, the threshold of independent parties collectively having information of a master secret key, the derived key being based, at least in part, on an identity associated with the authorized access and the information of the master secret key.

17. The computing system of claim 16, wherein the decrypting of the encrypted data using the derived key further includes decrypting of the encrypted data off the blockchain by:
fetch the encrypted data from a computer-readable storage medium that is separate from the blockchain to provide fetched encrypted data; and
using the derived key to decrypt the fetched encrypted data.

18. The computing system of claim 16, wherein the threshold of independent parties comprises independent key servers that hold an independent master secret key, and obtain the derived key includes:
send key requests to N key servers;
receive independent derived keys from R of the N key servers, where R≤N; and
when R≥T, combine at least T of the independent derived keys to reconstruct the derived key.

19. The computing system of claim 16, wherein the threshold of independent parties of the plurality of independent parties comprises a multi-party computation (MPC) committee and obtain the derived key includes:
send a key request to the committee;
perform, by the committee, an MPC protocol in which each member computes a derived-key share from its private share of a master secret key; and
combine at least t out of n derived -key shares to reconstruct the derived key.

20. The computing system of claim 19, wherein:
the committee comprises N independent entities, N being an integer, and the master key depends on at least T independent entities of the N independent entities contribute to the performing of the MPC to generate the master key, wherein T is a minimum threshold for generating the derived key.
